(19) United States
(12) Patent Application Publication
(10) Pub. No.: US 2023/0093716 A1
(43) Pub. Date: Mar. 23, 2023

(54) SATELLITE AND ANTENNA THEREFOR

(71) Applicant: WildStar, LLC, Hanover, NH (US)

(72) Inventors: Gregory Thane Wyler, Stuart, FL (US); Bobby Glenn Holden, Somerville, MA (US); Katelyn Sweeney, Natick, MA (US)

(21) Appl. No.: 17/948,970

(22) Filed: Sep. 20, 2022

Related U.S. Application Data
(60) Provisional application No. 63/246,140, filed on Sep. 20, 2021.

(51) Int. Cl. B64G 1/22; H01Q 1/28; H01Q 3/08; H01Q 1/08; B64G 1/32; B64G 1/10; B64G 1/24

(52) U.S. Cl. CPC B64G 1/222; H01Q 1/288; H01Q 3/08; H01Q 1/084; B64G 1/32; B64G 1/10; B64G 1/244

(57) ABSTRACT

A satellite in accordance with the present teachings has plural “thin” (i.e., panel-like) segments, which are coupled together and extendable along the in-track direction of movement of the satellite. One or more of these segments, which is advantageously an antenna panel, has the ability to “roll” relative other segments. This enables the satellite to establish and maintain direct pointing of the antenna panel to a targeted area on the ground. The antenna panel includes linear, electronically steerable array.

### STATEMENT OF RELATED CASES

This case claims priority of U.S. Pat. Appl. Ser. 63/246,140, filed Sep. 20, 2021, which is incorporated by reference herein.

### FIELD OF THE INVENTION

The present invention relates to satellites, and satellite antennas.

### BACKGROUND OF THE INVENTION

For broadband communications, and for a satellite that must point to a location on the earth that may not be directly below it, the satellite will likely include either a mechanically steerable panel or dish antenna, or an electronically steerable antenna (ESA).

The mechanically steerable antenna (dish or panel) usually steers in two axes in order to track a point on the ground. Its advantage is that the boresight of the antenna is always on the target, reducing the cosine-theta loss that comes from pointing to an off-boresight target. Disadvantages of this type of antenna include its significant mass and size, and the fact that it is bulky and hard to pack compactly for launch. Moreover, such antennas require two axes of motors that are continuously active to maintain tracking and substantial pointing control of the satellite body, to offset the continuous tracking motion.

ESAs provide a beam pointing and hopping benefit not available to fixed or mechanically steered panels or dishes. They also provide better off-axis gain, as well as an ability to null alternative signals. Yet, the performance of a communications satellite with an ESA is reduced by the significant mass, power, and thermal requirements of the ESA.

The ESA is often used on the Earth-facing surface of the satellite. Although the ESA offers faster steering than its mechanical steered brethren, it suffers significant beamforming-related losses as the ESA tracks a location away from its boresight. These losses may be compensated for by increasing the antenna's power output and/or narrowing its beam through the use of an increased number of antenna elements. But the increased power output and number of elements result in a significant increase in power-generation needs for the satellite, as well generating significantly more heat while in operation. This increases the required amount of solar panels, and the heat-reduction capacity of the satellite, which increases cost and mass.

The art would therefore benefit from improvements in the design of satellite antennas.

### SUMMARY

Embodiments of the invention provide a satellite and antenna design that avoid some of the costs and disadvantages of the prior art.

A satellite in accordance with the present teachings has plural “thin” (i.e., panel-like) segments, which are coupled together and extendable along the in-track direction of movement of the satellite. In some embodiments, one or more of these segments, which is advantageously an antenna panel, has the ability to “roll” relative other segments. This enables the satellite to establish and maintain direct pointing of the antenna panel to a targeted area on the ground.

In an illustrative embodiment, the satellite has two segments: a satellite body and an antenna panel. The satellite body serves as a common mounting platform, and houses most of the satellite's subsystems. In some embodiments, the satellite body includes a (fixed) phased array antenna on one of its major surfaces and solar panels on its other major surface. In some embodiments, this fixed antenna panel functions as a receive array.

The antenna panel, as its name suggests, also includes a phased array antenna, which in some embodiments functions as a transmit antenna. In some embodiments, the antenna panel also provides (solar) power collection as well. In accordance with the present teachings, the antenna panel is deployable. During launch, the antenna panel nests in a recess configured in one of the major surfaces of the satellite body. Once in orbit, the antenna panel is deployed such that the satellite body and antenna panel assume an “end-to-end” arrangement, wherein they are co-planar orientation and their longitudinal axes align with the in-track direction of movement of the satellite.

A coupling couples the antenna panel to the satellite to facilitate deployment of the antenna. In some embodiments, the coupling is a simple hinge, which enables a single rotary degree-of-freedom of movement.

In some other embodiments, a coupling between the satellite body and the antenna panel enables two rotary degrees of freedom of movement. In particular, the coupling permits, as a first degree of freedom, the antenna panel to partially rotate from its nested state (overlying the antenna panel in the aforementioned recess) to a deployed state. In some embodiments, the antenna rotates up to approximately 180 degrees to attain the deployed state. At 180 degrees of rotation, the antenna panel is substantially coplanar with the satellite body. The coupling also enables, as a second degree of freedom, the antenna panel to “roll” about its central axis, which aligns with the in-track direction of movement of the satellite. This ability to roll enables, after the antenna panel is deployed, the major surface of the antenna panel to be pointed in a different direction than that of the satellite body. As previously noted, this enables the satellite to establish and maintain direct pointing to a targeted area for communications. This coupling can be implemented as a single element, such as a rotary actuator having two rotary degrees of freedom of movement, or two elements, such as hinge, and a rotary actuator having one rotary degree of freedom that is attached to the hinge.

Thus, in an illustrative embodiment, the satellite is split into two segments, which can roll relative to one another. This “angular” pointing of the antenna panel substantially reduces the cosine-theta loss in the direction of rotation and thus substantially reduces the amount of power and thermal-rejection capabilities required on the satellite. The dynamic nature of the angular pointing enables the pointing to be accurately focused on the location desired, whether on the ground or in space.

A further benefit of some embodiments of the invention is the ability to utilize a linear single-axis phased array, which has a small fraction of the power needs and heat-rejection requirements of a two-axis phased array. The panels can thus be made very thin. In fact, for some use cases, the satellite functions without radiator panels and heat pipes due to the relatively high surface area to volume ratio of the satellite, as well as careful duty cycling. In such cases, simply reorienting one of the major surfaces of the satellite body and the antenna panel to deep space satisfies the satellite's thermal balance.

In some embodiments, a satellite in accordance with the present teachings can have more than one deployable antenna panel. In yet some further embodiments, the satellite includes multiple satellite body segments, and one or more deployable antenna panels.

As a consequence of the form factor of the satellite, and/or concerns with reliability, neither thrusters, reaction wheel (RW), nor control-moment gyro (CMG) based control systems are desirable for attitude control. Rather, in some embodiments, a magnetics-only based attitude control system is used. Such a system is disclosed in co-pending U.S. patent application Ser. No. 17/948,730 (atty docket: 2947-015us1, entitled “Magnetic Control of Spacecraft,”), which was filed on even date herewith and is incorporated by reference herein.

In some embodiments, the invention provides a satellite comprising: a first satellite body; and a first antenna panel, wherein the first satellite body and the first antenna panel are movably coupled to one another to provide a first degree of freedom (DOF) of movement and a second DOF of movement, wherein at least the second DOF is rotational, the first DOF enabling the first antenna panel to move from a stowed state to a deployed state, and the second DOF enabling the first antenna panel to roll, rotating about a first axis that aligns with an in-track direction of movement of the satellite.

In some other embodiments, the invention provides a satellite comprising: a satellite body, the satellite body a length, a width, and a thickness, wherein a ratio of the length to the width of the satellite body is in a range of about 2:1 to about 5:1; and an antenna panel, wherein the satellite body and the antenna panel are movably coupled to one another to provide a first degree of freedom (DOF) of movement, wherein the first DOF enables the antenna panel to move from a stowed state to a deployed state, wherein, in the deployed state, the antenna panel and the satellite body are in an end-to-end arrangement wherein respective longitudinal axes of the antenna panel and the satellite body align with an in-track direction of movement of the satellite when in orbit.

This summary is provided to briefly identify some aspects of the present disclosure, which are described further below. It is not intended to limit the scope of any claims.

### BRIEF DESCRIPTION OF THE DRAWINGS

FIGS. 1A-1C depict a satellite in accordance with an illustrative embodiment of the present invention.

FIGS. 2A through 2E depicts embodiments of couplings for movably coupling portions of the satellite to one another.

FIG. 3 depicts a second illustrative embodiment of a satellite in accordance with the present teachings.

FIG. 4 depicts a third illustrative embodiment of a satellite in accordance with the present teachings.

FIG. 5A depicts plural instances of a satellite in accordance with the present teachings, wherein the satellites are coupled together.

FIG. 5B depicts a notional retention mechanism for coupling the satellites of FIG. 5A together.

FIG. 6 depicts a propulsion system coupled to a stack of coupled satellites in accordance with the present teachings.

FIG. 7 depict a high drag state of a satellite in accordance with the illustrative embodiment of the invention.

FIGS. 8A-8B depict an embodiment of a satellite with an optical link for transmitting data to the ground, in accordance with the present teachings.

FIG. 9 depicts an embodiment of a satellite with optical links for inter-satellite communications, in accordance with the present teachings.

### DETAILED DESCRIPTION

The following merely illustrates the principles of the disclosure. It will thus be appreciated that those skilled in the art will be able to devise various arrangements which, although not explicitly described or shown herein, embody the principles of the disclosure, and are included within its spirit and scope. More particularly, while numerous specific details are set forth, it is understood that embodiments of the disclosure may be practiced without these specific details and in other instances, well-known circuits, structures, and techniques have not been shown in order not to obscure the understanding of the disclosure.

Furthermore, all examples and conditional language recited herein are principally intended expressly to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future; that is, any elements developed that perform the same function, regardless of structure.

Thus, for example, it will be appreciated by those skilled in the art that the diagrams herein represent conceptual views of illustrative structures embodying the principles of the disclosure.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof, any element expressed as a means for performing a specified function is intended to encompass any way of performing that function including, for example, a) a combination of circuit elements which performs that function or b) software in any form, including, therefore, firmware, microcode, or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

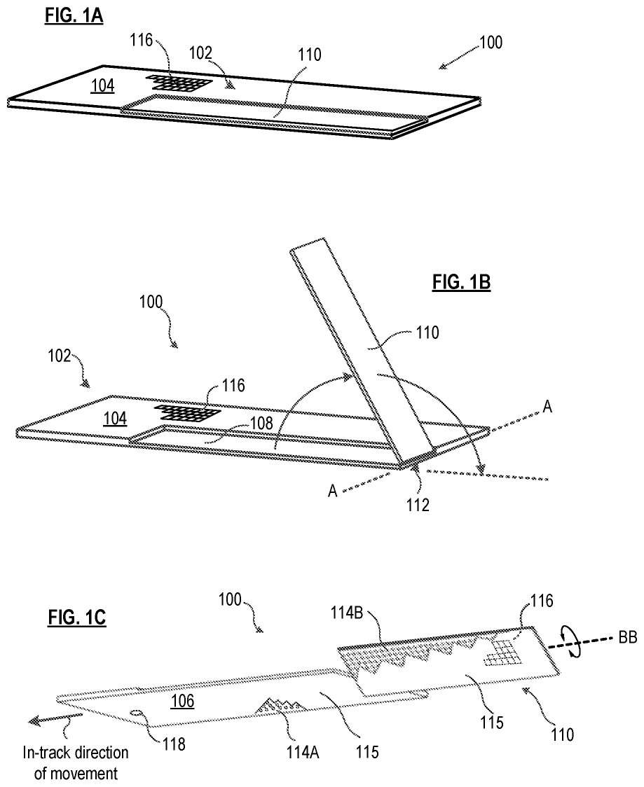

FIGS. 1A through 1C depicts satellite 100 in accordance with an illustrative embodiment of the present invention. Satellite 100 includes satellite body 102 and antenna panel 110, which are coupled together via coupling 112. FIG. 1A depicts satellite 100 with antenna panel 110 in a stowed position, such as for launch. FIGS. 1B and 1C depict satellite 100 with antenna panel 100 deployed.

Satellite 100 has a “flat” form factor; it is much longer and wider than it is thick, and has an aspect ratio more similar to that of a solar panel than any conventional satellite. In some embodiments, the satellite is quite small. For example, in some embodiments in which satellite 100 has a single satellite body 102 and a single antenna panel 110, the satellite has a mass of about 10 kilograms. In some embodiments, satellite body 102 has a length in the range of about 0.5 meters to about 1 meter, a width in a range of about 10 to 50 centimeters (cm), and a thickness of about 1 to about 5 cm. More generally, satellite body 102 typically has an aspect ratio (length to width) in the range of about 2:1 to about 5:1. Furthermore, satellite body 102 has a ratio of length to thickness that is typically in the range of about 10:1 to about 40:1. Since there is a practical minimum thickness (due to onboard subsystems), the ratio of length to thickness tends to increase as the length of satellite body 102 increases.

Antenna panel 110 has a length that is in the range of about 60% to about 80% of the length of the satellite body, a width of about 5 to about 30 cm, and a thickness of about 1 to about 3 cm. The thickness of antenna panel 110 is typically in the range of about 20 to 70 percent of the thickness of satellite body 102.

Satellite body 102, which in the illustrative embodiment comprises aluminum, serves as a mounting platform for all of the satellite's subsystems. In the illustrative embodiment, satellite body 102 includes one or more data processing systems, multiple processors, and subsystems having various functionalities, as are typically found on satellites. Each data processing system includes one or more processors, primary memory, data storage, software, and I/O. In some embodiments, satellite body 102 includes three data processing systems:
The On-Board Computer (OBC), which handles various commands, transmits telemetry, manages the health of the satellite, processes payload feedback signals, and hosts and commands the attitude determination and control system (ADCS). The OBC interfaces with various sensors and actuators to implement such functionality.
A second data processing system that addresses the control of the payload (telecommunications).
A third data processing system that is addresses the control of the ADCS elements. In the illustrative embodiment, the ADCS elements include magnetic/magnetometer elements.

Subsystems within satellite body 102 include command and data handling (C&DH), ADCS, orbit determination, (solar) power collection, power storage, power distribution, among any other standard satellite subsystems. Those skilled in the art are familiar with the operation and design of the aforementioned data processing systems and the various satellite subsystems. Consequently, they will not be discussed in any significant further detail so as to maintain focus on features that are germane to an understanding of the present invention.

Major surface 104 of satellite body 102 includes solar cells 116, which replenish on-board power storage (e.g., batteries, etc.) after an initial battery charge is depleted. In some embodiments, major surface 106 of satellite body 102 includes phased array antenna 114A, such as a linear, single-axis phased array antenna. In some embodiments, phased array antenna 114A is a receive array, for receiving transmissions. Phase array antenna 114A is bonded to satellite body 102 with nonconductive adhesive and spacers. The bond between antenna 114A and satellite body 102 increases the stiffness of satellite 100, and is an important part of its design (in light of its very “thin” architecture). In some embodiments, phased array antenna 114A is covered by protective material 115, such as polyimide, commonly used as a protective film for satellites. Other materials known to those skilled in the art as being suitable for such purpose may alternatively be used.

Antenna panel 110 includes phased array antenna 114B, such as a linear, single-axis phased array antenna. In some embodiments, phased array antenna 114B is a transmit array. Antenna array 114B is of similar construction as array 114A, however, instead of being bonded to the satellite, this array is mounted to the satellite with a deployable and rotating joint, as discussed further below. Like array 114A, phased array antenna 114B is covered by protective material 115. In some embodiments, solar cells 116 are disposed on antenna panel 110, such as on the surface opposite to that of phased array antenna 114B.

As best shown in FIG. 1B, major surface 104 of satellite body 102 includes recess 108, which receives antenna panel 110. The antenna panel is nested within recess 108 for storage, ground transport, and launch. Once satellite 100 is in orbit, antenna panel 110 is deployed.

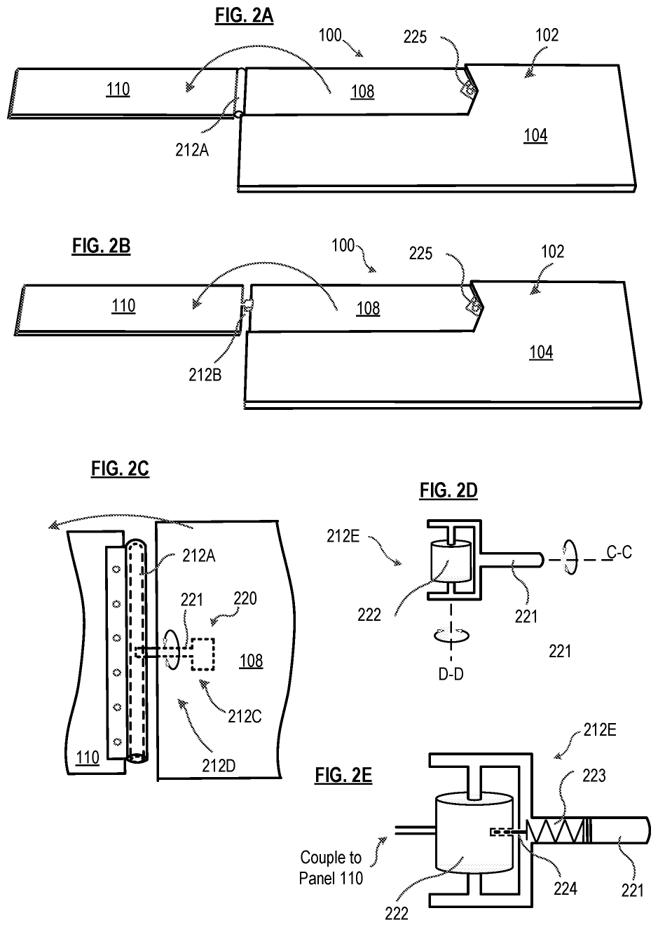

In the illustrative embodiment, antenna panel 110 is deployed by rotating away from recess 108, about axis A-A. The antenna panel 110 is typically rotated 180 degrees for telecommunications use, so the antenna panel is coplanar with satellite body 102 and extends in the in-track direction of movement of satellite 110, such as depicted in FIG. 1C. Such rotation can be implemented by an embodiment of coupling 112 that provides a single rotary degree of freedom of movement. Coupling 112 can be either passive or active. Exemplary specific embodiments of coupling 112 are described in conjunction with FIGS. 2A-2E.

In some embodiments, in addition to being able to rotate away from recess 108 about axis A-A, antenna panel 110 is capable of “rolling.” That is, antenna panel is capable of at least partially rotating about axis B-B, as depicted in FIG. 1C. Due to the dimensions of antenna panel 110, axis B-B is referred to herein as the “longitudinal” axis of the antenna (and satellite body 102). What is important here is that the rotation being referenced changes the broadside pointing direction of antenna panel 110. Thus, phased array 114B of antenna panel 110 can electronically steer a beam in the in-track direction while antenna panel 110 itself can roll in the cross-track direction to maintain highly directional pointing. This further reduces the power needs and the heat-rejection requirements of the satellite. Such rotation can be implemented by embodiments of coupling 112 that provides two rotary degrees of freedom of movement. Such embodiments can comprise a single device for providing both rotary degrees of freedoms, or, alternatively, two separate devices, each providing a single rotary degree of freedom about different axes. However implemented, embodiments of coupling 112 can actively actuate movement about only one, or both of the two rotational axes. This is described in further detail in conjunction with FIGS. 2A-2E.

As previously mentioned, in some embodiments, antenna panel 110 and satellite body 102 are coupled in a manner or by a device that enables one rotary degree-of-freedom of movement suitable for deploying antenna panel 110.

In an embodiment depicted in FIG. 2A, this is implemented via passive hinge 212A. A force that causes rotation of antenna panel 110 is imparted thereto via a spring, explosive bolt, etc., such as can be situated near the end of antenna panel 110 that is distal to the location of hinge 212A. Coupled to hinge 212A and urged into motion at its opposite end, antenna panel 110 will simply rotate about axis A-A (FIG. 1B). In some embodiments, once rotated 180 degrees so that it is substantially coplanar with the satellite body 102, the hinge locks in position.

In the illustrative embodiment, the source of force is associated with release device 225. When nestled in recess 108, antenna panel 110 engages release device 225. This device ensures that antenna panel 110 remains within recess 108 until it is to be deployed when satellite 110 is in orbit.

In some embodiments, the source of force (and restraint) is a non-explosive actuation device, such as a split spool release device. In such a device, a female threaded spool is wrapped with wire. This wire holds back the spool. At the ends of the wire, where it is attached to satellite body 102 is a small section of fuse wire. Once energized, this fuse wire heats to a temperature beyond its melting point, and releases the wrapped wire. The wrapped wire acts as a spring and uncoils rapidly, which then releases the spool. The spool and restraining bolt are then allowed to deploy with antenna panel 110.

In some embodiments, release device 225 is magnetic latch. That is, a magnetic/magnetized/ferromagnetic/ferrimagnetic member in recess 108 couples to a magnetic/magnetized/ferromagnetic/ferrimagnetic region of the antenna panel 110 (either the panel itself, or plate disposed thereon). To decouple, the member in the recess is withdrawn (i.e., the member is actuated). In yet some further embodiments, release device 225 is an explosive bolt that couples antenna panel 110 to recess 108.

In an embodiment depicted in FIG. 2B, deployment of antenna panel 110 is via rotary coupling 212B, which is an active device that provides the force for deployment. Rotary coupling 212B provides one rotary degree-of-freedom of movement. In some embodiments, rotary coupling 212B includes electric motor 220 and actuator shaft 221 (see FIG. 2C), the latter used to deliver the motor's torque to antenna panel 110.

In some other embodiments, antenna panel 110 and satellite body 102 are coupled in a manner or by a device that enables two rotary degrees-of-freedom of movement, one for deploying antenna panel 110, and one for “rolling” it to alter its broadside pointing direction. Such embodiments of coupling 112 may be implemented by one or more mechanisms.

In an embodiment depicted in FIG. 2C, coupling 212D includes a passive element that provides a first rotary degree-of-freedom of movement and an active element that provides the second rotary degree-of-freedom of movement. Specifically, coupling 212D includes a passive hinge, such as hinge 212A, for deploying antenna panel 110, and rotary coupling 212C for rolling it. Unlike rotary coupling 212B, which causes antenna panel 110 to rotate about axis A-A (FIG. 1B), rotary coupling 212C causes antenna panel 110 to rotate about axis B-B (FIG. 1C).

Depicted notionally in FIGS. 2D and 2E is coupling 212E, which is another embodiment of a coupling that provides two rotary degrees of freedom. Rotary coupling 212E includes actuator shaft 221 and rotary component 222. Movement of rotary component 222 about axis D-D, which will enable antenna panel 110 to rotate away from satellite body 102, can be passive or active. For example, the motive force that drives movement of antenna panel 110 can be sourced from a spring, explosive bolt, etc., which is positioned near the opposite end of antenna panel 110. Coupled to rotary component 222 and urged into motion at its opposite end, antenna panel 110 will simply rotate about axis D-D. In some embodiments, once rotated 180 degrees so that it is substantially coplanar with the satellite body 102, rotary component 222 is locked into position. This is depicted notionally in FIG. 2E.

Referring now to FIG. 2E, when rotary component 222 rotates 180 degrees to fully deploy antenna panel 110, an opening in the rotary component is brought into alignment with the longitudinal axis of actuator shaft 221. Spring 223, which is disposed in actuator shaft 221, biases pin 224 against rotary component 222. Once the opening in rotary component 222 aligns with actuator shaft 221, pin 224 is forced via the release of the spring's stored energy, into the opening, preventing further movement of rotary component 222.

The second rotational degree of movement is coupled to antenna panel 110 via actuator shaft 221, which, in turn, is coupled to a motor, not depicted. The motor drives actuator shaft 221 into rotary motion about axis C-C (FIG. 2D). This will cause antenna panel 110 to “roll” about axis B-B (see FIG. 1C). In some other embodiments, rotary component 222 is also coupled to a motor, such that rotation of antenna panel 110 (about axis A-A of FIG. 1B) can be controlled as desired.

In some other embodiments, rather than partially rotating to deploy, antenna panel 110 is linearly displaced; that is, it is pushed laterally out of recess 108 to the deployed position. Once deployed, antenna panel can be rolled as previously discussed. In such an embodiment, coupling 212 has one linear DOF and one rotational DOF.

In the art of phased arrays, individual phase-shifting semiconductor chips either control a single patch element, or multiple patch elements, often in a column. This columnar phased array is called a linear phased array and enables the array to steer a beam around the axis formed by the column itself. Such orthogonal steering is very cost and power effective because it requires only one phase shift per column. However, the downside is that it can only electrically steer the beam in the direction orthogonal to the columns.

Thus, in accordance with the present teachings, the mechanical steering of antenna panel 110 can be used to twist the beam focus in elevation, while the active elements can manage the azimuth steering. In yet some other embodiment, an electro-mechanical RF switch is used, wherein the switch chooses between at least two different delay lines to each of the patches, resulting in a change in elevation. This enables the combination of elevation and azimuthal steering to be active and switched in microseconds. In some further embodiments, antenna panel 110 includes a columnar-designed linear phased array, where there are multiple stacks to the column on top of each other, but controlled differently to enable this limited active beam steering in the axis in-line with the columns themselves. Either of these versions of the linear phased array can be described as a “hybrid linear array”.

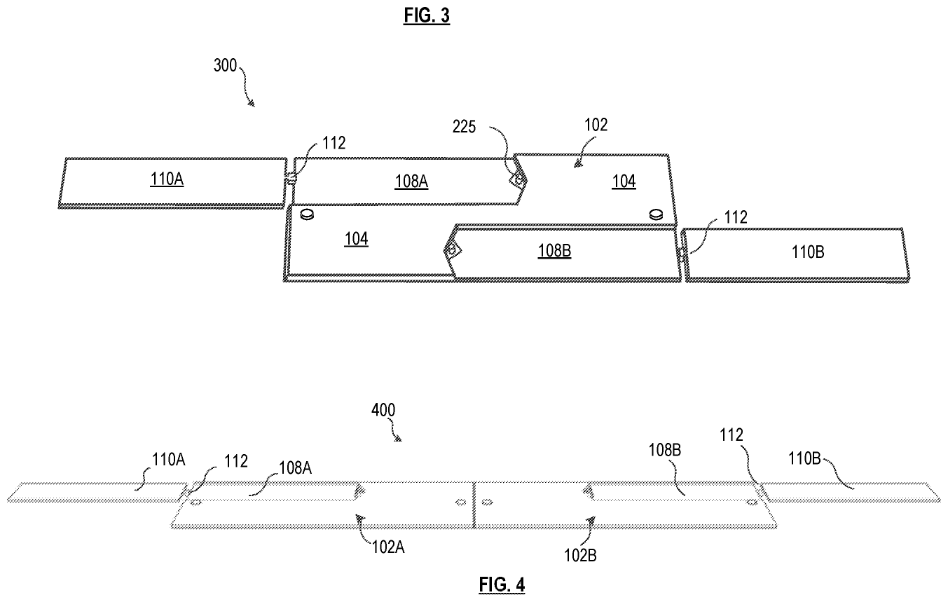

In the illustrative embodiment depicted in FIGS. 1A, etc., a satellite in accordance with the present teachings has a single satellite body 102 and a single antenna panel 110. In some other embodiments, a satellite in accordance with the invention has a single satellite body 102 and more than one antenna panel 110. FIG. 3 depicts satellite 300 having one satellite body 102 and two antenna panels 110A and 110B. Increasing the width of satellite body 102 would support even further antenna panels.

In some other embodiments, a satellite in accordance with the invention has more than one satellite body 102 and has multiple antenna panels 110. FIG. 4 depicts satellite 400 having two satellite bodies 102 and two antenna panels 110. In this illustrative embodiment, the two satellite bodies 102 are rigidly coupled to one another. It is notable that this arrangement could support additional antenna panels 110 without altering the width of satellite bodies 102.

In some embodiments in which multiple antenna panels 110 are used, the antenna panels can have different lengths. This is useful for a variety of reasons, including enable communications at different frequencies or operating at the same frequency with a different beam pattern. And of course, with multiple antenna panels 110 on satellite, the antenna panels can be directed to different locations. Moreover, the electronically steerable antenna on each such antenna panel can have a different offset angle.

Satellites in accordance with the present teaching present a very small surface area in the in-track direction, which provides a number of benefits, as follows.
The satellite can have any length along the in-track direction of movement without notably increasing drag.
Since the RF pattern on the ground becomes increasingly narrow as panel length increases, embodiments of the invention enable very thin slices of radio-frequency-power flux density to reach the ground while maintaining a very thin satellite profile.
The likelihood of collisions with space debris or other satellites is reduced.

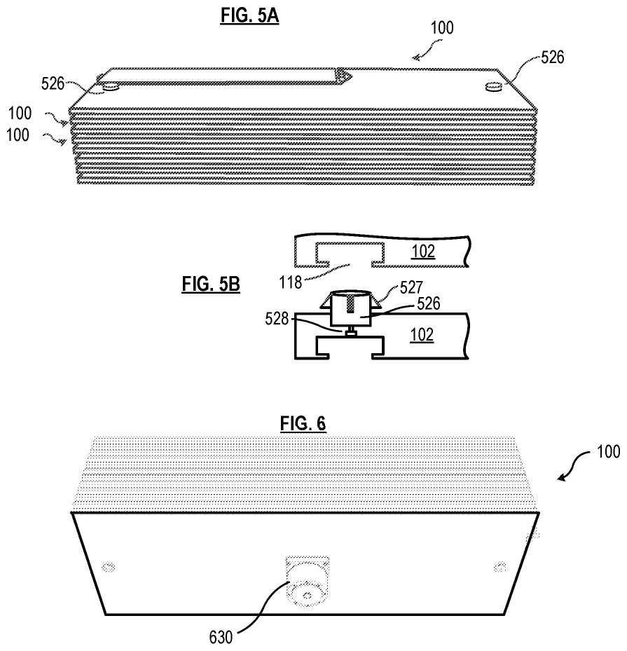

In some embodiments, satellite 100 is physically adapted to be stackable, such as to launch plural satellites 100. FIG. 5A depicts a plurality of satellites 100 stacked. Antenna panel 110 is nested in recess 108 for stacking. Each satellite includes a retention mechanism by which adjacent satellites in the stack are coupled to one another. In the embodiment depicted in FIG. 5B, protrusions 526 on surface 104 of satellite body 102 are received by cooperating openings 118 on surface 106 of satellite body 102 of an overlying satellite 102. Protrusions 526 include barbs 527 that latch within opening 118. Once in orbit, satellites 100 can be successively released by pyrotechnic fastener 528. In some other embodiments, latches that inter-lock between satellites 100 are employed, so that the first-in-time-to-be-released satellite 100 must be released in order for the next-in-time-satellite to unlatch. In other embodiments the satellites are released in other orders. In some other embodiments, the retention mechanism is magnetic (e.g., a magnetic latch, etc.). Still other retention mechanisms for coupling satellites 100, as will occur to those skilled in the art in light of the present disclosure, may suitable be used.

In some embodiments, stacked satellites 100 include at least one propulsion mechanism, such as an ionic engine, to provide a motive force to the coupled satellites after they are released from a launch vehicle. This is useful in positioning the satellites at a specified altitude. FIG. 6 depicts propulsion mechanism 630 coupled to one of satellites 100 in a stack thereof. In some embodiments, the power systems (e.g., batteries, etc.) of more than one of satellites 100 in a stack are electrically coupled to use the combined power to power the propulsion system.

In some embodiments, leading edge of satellite 100 (with respect to its proposed velocity vector) includes a structural adaption for absorbing energy from collisions with other objects in space, thereby protecting satellite 100. Thus, referring to FIG. 2A for example, the forward (left) edge of antenna panel 110 and the forward edge of satellite body 102 is covered by a crushable material (such as a layer of a honeycomb-structured material).

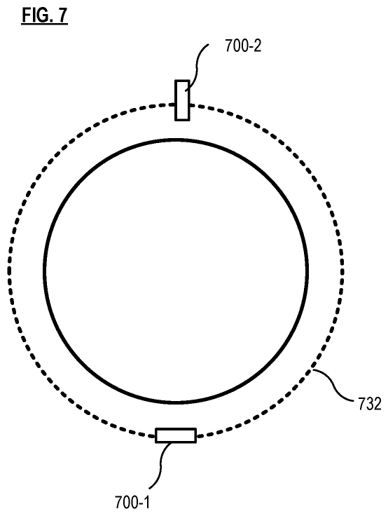

To deorbit satellite 100, it is re-oriented to a “high drag” state. In this state, a maximal amount of the surface of satellite 100 faces the in-track direction of movement. This is depicted in FIG. 7. As shown in this Figure, two satellites 700-1 and 700-2 are in orbit 732 around the Earth. Satellite 700-1 is in a normal (low) drag state, wherein a minimal amount of surface area faces the in-track direction of movement. Satellite 700-2 is in the high drag state, wherein a maximal amount of its surface area faces the in-track direction of movement.

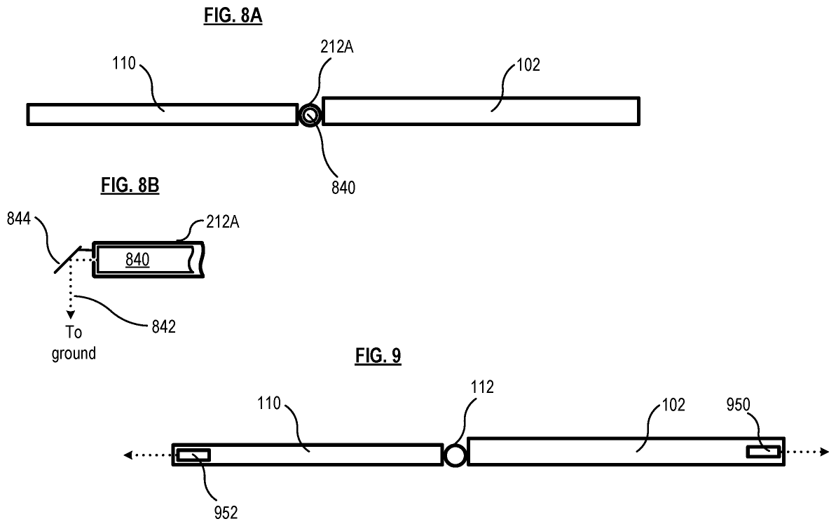

FIGS. 8A and 8B depict an embodiment of satellite 100 having a first optical link. The optical link is implemented as laser 840 and mirror 844. Laser 840 has form factor suitable for integration with coupling 212, such as a circular cross section for integration into hinge 212A. Since satellite panel 110 will typically oriented so that its broadside pointing direction is towards the ground, the long axis of hinge 212A will be orthogonal to the ground. Consequently, mirror 844 is oriented at 45 degrees with respect to the optical axis of laser 840 to direct laser light emitted from the laser to the ground.

FIG. 9 depicts an embodiment wherein satellite 100 includes additional optical links. Whereas the first optical link of FIGS. 8A and 8B is primarily intended for delivering data to ground-based receives, the optical links provided by lasers 950 and 952 are primarily intended for communications with other satellites. In the embodiment depicted in FIG. 9, lasers 950 and 952 are oriented to direct laser light in the in-track direction, one in the forward direction, and the other rearward. In further embodiments, these additional optical links for inter-satellite communications can include fixed or movable mirrors that can be used to direct the laser light off-axis with respect to the in-track direction, such as to communicate with satellites in other orbits.

In some embodiments, the attitude determination and control system for use with satellites described herein is a magnetics only system. The system and method is described in co-pending U.S. patent application Ser. No. 17/948,730 (atty docket: 2947-015us1, entitled “Magnetic Control of Spacecraft,”), as previously referenced.

The method for controlling attitude via magnetics alone involves:
a) assessing a current attitude of the satellite at a current time and at a current location using magnetometry;
b) setting a desired attitude for the satellite at a future time in a future location;
c) developing a set of waypoints for the satellite, wherein the waypoints provide the attitude of the satellite at plural locations between the current location and the future location, wherein the waypoints are based on a model of the Earth's magnetic field, wherein the model provides the state of the magnetic field at each waypoint; and
d) actuating a plurality of magnetorquers to induce torques that achieve a small as possible difference between the attitude of the satellite between each waypoint and achieving the desired attitude at the future location, and wherein the magnetorquers are the sole means of inducing rotation of the satellite to attain the desired attitude.

The waypoints are developed by:
a) estimating a progression of position of the satellite in an orbit thereof, the progression defining the set of waypoints;
b) calculating a state of the Earth's magnetic field at each waypoint; and
c) defining an orientation trajectory that specifies intermediate orientations for the first satellite that are achievable, via magnetic-induced rotation alone, such that the desired attitude is achieved at the future time.

The state of the Earth's magnetic field can be calculated by receiving data obtained from other satellites having the same orbital plane as the satellite of interest, and that are advanced in the orbit relative to the satellite of interest. To this end, in some embodiments, each satellite 100, etc., includes inter-satellite communications capability. Such communications can be via RF or optical.

It is to be understood that the disclosure describes a few embodiments and that many variations of the invention can easily be devised by those skilled in the art after reading this disclosure and that the scope of the present invention is to be determined by the following claims.

What is claimed:

1. A satellite comprising:
a first satellite body; and
a first antenna panel, wherein the first satellite body and the first antenna panel are movably coupled to one another to provide a first degree of freedom (DOF) of movement and a second DOF of movement, wherein at least the second DOF is rotational,
the first DOF enabling the first antenna panel to move from a stowed state to a deployed state, and the second DOF enabling the first antenna panel to roll, rotating about a first axis that aligns with an in-track direction of movement of the satellite.

2. The satellite of claim 1 wherein the first antenna panel comprises includes a first linear, electronically steerable antenna array.

3. The satellite of claim 2 wherein the first satellite body includes a second linear, electronically steerable antenna array.

4. The satellite of claim 1 wherein the first DOF is rotational.

5. The satellite of claim 2 wherein the first DOF is rotational.

6. The satellite of claim 1 wherein the first DOF is linear.

7. The satellite of claim 5 further comprising a first rotary coupling, wherein the first rotary coupling provides the first DOF and the second DOF, and wherein the first rotary coupling is configured so that the first DOF moves the first antenna panel in the in-track direction of movement, and the second DOF moves the first antenna panel in a cross-track direction of movement.

8. The satellite of claim 7 wherein the first rotary coupling passively facilitates movement with respect to the first DOF and actively drives movement with respect to the second DOF.

9. The satellite of claim 7 wherein the first rotary coupling actively drives movement with respect to the first DOF and actively drives movement with respect to the second DOF.

10. The satellite of claim 1 wherein the first satellite body comprises a first major surface, wherein the first major surface includes a recessed region, wherein, in the stowed state, the first antenna panel is disposed in the recessed region.

11. The satellite of claim 1 wherein the first antenna panel is rotated through 180 degrees from the stowed state to the deployed state.

12. The satellite of claim 10 wherein the first major surface of the first satellite body includes a linear, electronically steerable antenna array and the first satellite body comprises a second major surface, wherein the second major surface comprises an array of solar cells.

13. The satellite of claim 1 comprising a second antenna panel movably coupled to the first satellite body to provide the first DOF of movement and the second DOF of movement.

14. The satellite of claim 5 comprising a second antenna panel and a second rotary coupling, wherein the second rotary coupling movably couples the second antenna panel to the first satellite body to provide the first DOF of movement and the second DOF of movement.

15. The satellite of claim 12 wherein a length of the first linear, electronically steerable array and a length of the second linear, electronically steerable array are different.

16. The satellite of claim 1 comprising a second satellite body, wherein the second satellite body couples to the first satellite body, wherein as coupled, the first satellite body and the second satellite body align with the in-track direction of movement when in orbit.

17. The satellite of claim 1 comprising a retention mechanism that, when the satellite is in a stowed configuration, enables the satellite to couple to an adjacent overlying or underlying satellite, thereby creating a stack of coupled satellites.

18. The satellite of claim 17 comprising a propulsion system coupled to one of the satellites in the stack.

19. The satellite of claim 18 wherein a power system of two or more of the coupled satellites in the stack are electrically coupled to power the propulsion system.

20. The satellite of claim 1 comprising a magnetics-only attitude control system, wherein the attitude control system utilizes torque generated by an interaction of the magnetosphere with internally generated magnetic moments to control satellite attitude, and wherein the attitude control system does not utilize thrusters, reactions wheels, or control-moment gyros.

21. The satellite of claim 1 comprising:
a passive hinge, wherein the passive hinge provides the first DOF; and
an optical link coupled to the passive hinge, wherein the optical link provides a communications link between the satellite and a ground-based receiver.

22. The satellite of claim 21 wherein the optical link comprises a laser and a mirror, wherein the mirror receives laser light emitted from the laser, and reflects the received laser light towards the ground-based receiver.

23. The satellite of claim 1 comprising a first optical link, wherein the first optical link includes a first laser, wherein the first laser emits a laser beam in a forward, in-track direction of movement of the satellite.

24. The satellite of claim 23 comprising a second optical link, wherein the second optical link includes a second laser, wherein the second laser emits a laser beam in a rearward, in-track direction of movement of the satellite.

25. The satellite of claim 1 comprising an optical link, wherein the optical link includes a laser, wherein the laser emits a laser beam in a rearward, in-track direction of movement of the satellite.

26. A satellite comprising:
a satellite body, the satellite body a length, a width, and a thickness, wherein a ratio of the length to the width of the satellite body is in a range of about 2:1 to about 5:1; and
an antenna panel, wherein the satellite body and the antenna panel are movably coupled to one another to provide a first degree of freedom (DOF) of movement, wherein the first DOF enables the antenna panel to move from a stowed state to a deployed state, wherein, in the deployed state, the antenna panel and the satellite body are in an end-to-end arrangement wherein respective longitudinal axes of the antenna panel and the satellite body align with an in-track direction of movement of the satellite when in orbit.

27. The satellite of claim 26 wherein a ratio of the length to the thickness of the satellite body is in a range of about 10:1 to about 40:1.

28. The satellite of claim 26 wherein the antenna panel has a length that is in a range of about 60 to about 80 percent of the length of the satellite body.

29. The satellite of claim 26 wherein the antenna panel has a thickness that is in a range of about 20 to about 70 percent of the thickness of the satellite body.
